(19) United States
(12) Patent Application Publication
(10) Pub. No.: US 2017/0297502 A1
(43) Pub. Date: Oct. 19, 2017

(54) PROJECTOR SYSTEM FOR A BUMPER OF A VEHICLE

(71) Applicant: Faraday&Future Inc., Gardena, CA (US)

(72) Inventors: Richard S. Kim, Los Angeles, CA (US); Victor Manuel Bello, Torrance, CA (US); Matthew Joseph Coburn, Redondo Beach, CA (US)

(21) Appl. No.: 15/488,412

(22) Filed: Apr. 14, 2017

Related U.S. Application Data
(60) Provisional application No. 62/322,914, filed on Apr. 15, 2016.

(51) Int. Cl. B60R 11/02; H04N 9/31; B60R 11/00

(52) U.S. Cl. CPC B60R 11/0229; H04N 9/31; B60R 11/02; B60R 2011/004; B60R 2011/0282

(57) ABSTRACT

A projector system for a vehicle includes an external member having at least a portion formed of a transparent material, the portion including a translucent surface, and a projector configured to project an image onto the translucent surface.

### CROSS-REFERENCE TO RELATED APPLICATIONS

The present application claims the benefit of U.S. Provisional Application No. 62/322,914, filed Apr. 15, 2016, the entirety of which is hereby incorporated by reference.

### TECHNICAL FIELD

The present disclosure relates generally to a projector system, and more particularly, to a projector system for a bumper of a vehicle.

### BACKGROUND

Vehicles are often required to relay information to individuals outside of the vehicle. The messages can be as simple as honking a horn to get attention or actuating a turn signal to indicate a lane change of the vehicle. These means of providing information are inherently limited in the complexity of the information that can be provided. For example, the indications are typically limited to a monotone audible output or a single blinking light.

The disclosed projector system is directed to mitigating or overcoming one or more of the problems set forth above and/or other problems in the prior art.

### SUMMARY

One aspect of the present disclosure is directed to a projector system for a vehicle. The projector system includes an external member including at least a portion formed of a transparent material, the portion including a translucent surface, and a projector configured to project an image onto the translucent surface.

Another aspect of the present disclosure is directed to a method of displaying an image onto a vehicle. The method includes receiving, with a projector, a signal indicative of a message, and projecting, with the projector, the image based on the signal onto an external surface of the vehicle.

Yet another aspect of the present disclosure is directed to a vehicle. The vehicle includes a projector system having an external member including a translucent surface, and a projector configured to project an image onto the translucent surface, the external member including at least a portion formed of a transparent material and having the translucent surface.

### BRIEF DESCRIPTION OF THE DRAWINGS

FIG. 1 is a diagrammatic illustration of an exemplary embodiment of an exemplary vehicle.

FIG. 2 is a diagrammatic illustration of an exemplary embodiment of a front end of the exemplary vehicle of FIG. 1.

FIG. 3 is a diagrammatic illustration of an exemplary embodiment of a rear end of the exemplary vehicle of FIGS. 1 and 2.

FIG. 4 is a flowchart illustrating an exemplary method that may be performed in production of the exemplary vehicle of FIGS. 1-3.

FIG. 5 is a block diagram of an exemplary projector system that may be used with the exemplary vehicle of FIGS. 1-3.

### DETAILED DESCRIPTION

The disclosure is generally directed to a projector system for projecting images onto at least a portion of a surface of an external member of a vehicle. In some embodiments, the external surface includes an area on a front of the vehicle and/or an area on a rear of the vehicle. More particularly, in some embodiments, the system includes a short throw high definition projector positioned in line with a grill area or bumper on the front of the vehicle and/or a trunk portion or bumper on the rear of the vehicle. In an illustrated embodiment, the system includes a short throw high definition projector positioned in line with at least one of the front and rear bumpers, as the external member(s) to project an image on at least a portion of a surface of the bumper(s). The bumper may include an automotive grade flexible and transparent polymer. That is, at least a portion or the entirety of the bumper may be formed of the transparent material. The portion or the entirety of the bumper formed of the transparent polymer may be back painted with a pearlescent coating to provide a desirable translucent surface or lens. The projector system may project images onto the translucent surface related to safety, aesthetics, vehicle status, entertainment, and/or car sharing.

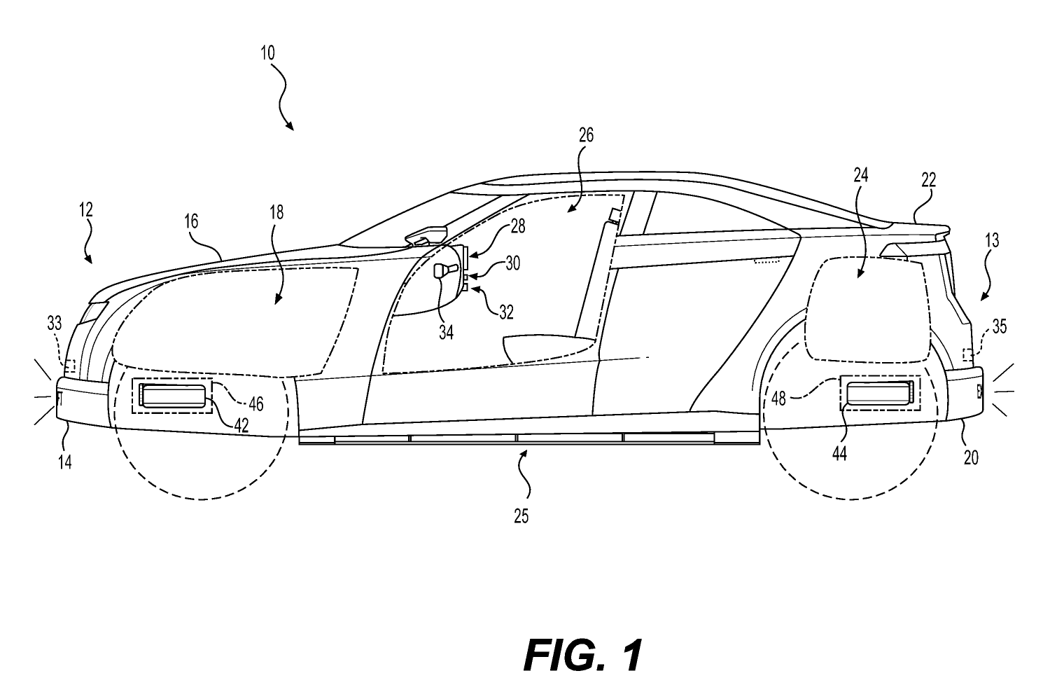

FIG. 1 provides a diagrammatic illustration of an exemplary embodiment of an exemplary projector system of an exemplary vehicle 10. Vehicle 10 may be an automobile having any body style, such as a sports car, a coupe, a sedan, a pick-up truck, a station wagon, a sports utility vehicle (SUV), a minivan, a race car, and/or a conversion van. Vehicle 10 may be other types of vehicles, such as a bus, a train, and/or an airplane. Vehicle 10 may be an electric vehicle, a fuel cell vehicle, a hybrid vehicle, or a conventional internal combustion engine vehicle. Vehicle 10 may be configured to be operated by a driver occupying the vehicle, remotely controlled, and/or autonomously operated.

As illustrated in FIG. 1, vehicle 10 includes a front end 12 having a front bumper 14 and a front hood 16 enclosing a front cargo space 18. Vehicle 10 includes a rear end 13 having a rear bumper 20 and a rear hood 22 enclosing a rear cargo space 24. Vehicle 10 includes a battery pack 25 positioned in an undercarriage and configured to generate power to drive wheels of vehicle 10. Vehicle 10 may include sensors, for example, functionally associated with battery pack 25 in order to detect a status of battery pack 25, such as a battery life. Vehicle 10 further includes a cabin 26 configured to house occupants and instruments, such as a user interface 28, a microphone 30, a camera 32, and a manual input 34. Vehicle 10 further includes one or more projector(s) 42, 44 contained in compartments 46, 48 and configured to project images onto an external member of vehicle 10, such as bumpers 14, 20.

User interface 28 may be any device configured to receive input from the user and transmit data. For example, user interface 28 may have a display including an LCD, an LED, a plasma display, or any other type of display. User interface 28 may also provide a graphical user interface (GUI) presented on the display for user input and data display. User interface 28 may further include input devices, such as a touchscreen, a keyboard, a mouse, and/or a tracker ball.

Camera 32 may include any device configured to capture videos and/or images of cabin 26 and generate signals and/or data to be processed to visually detect the surrounding environment. For example, camera 32 may be used in conjunction with image processing software, e.g., image recognition software, such that the software may distinguish a person from inanimate objects, and distinguish identities, facial features, and/or other biometric aspects of users. The software may also be configured to detect gestures by the people based on relative positions and movements of facial features, heads, arms, fingers, legs, and/or feet. In some embodiments, the software may be configured to process the image to determine conditions of the people, such as sleep deprivation, intoxication, attentiveness, distraction, and/or other physical or mental conditions. Camera 32 may be configured to be adjusted by a motor (not shown) to improve an image of the user. For example, the motor may be configured to tilt camera 32 in a horizontal and/or vertical plane to substantially center on occupants of vehicle 10. The motor may also be configured to adjust the focal point of the camera 32 to enhance detection of the occupant(s).

Vehicle 10 can optionally include one or more cameras and/or sensors mounted to capture video and/or images and/or movement in areas exterior to vehicle 10. For example, additional cameras 33 and 35 can be mounted at front end 12 and rear end 13, respectively, of vehicle 10. Video and/or images captured by cameras 33, 35 can be displayed on user interface 28.

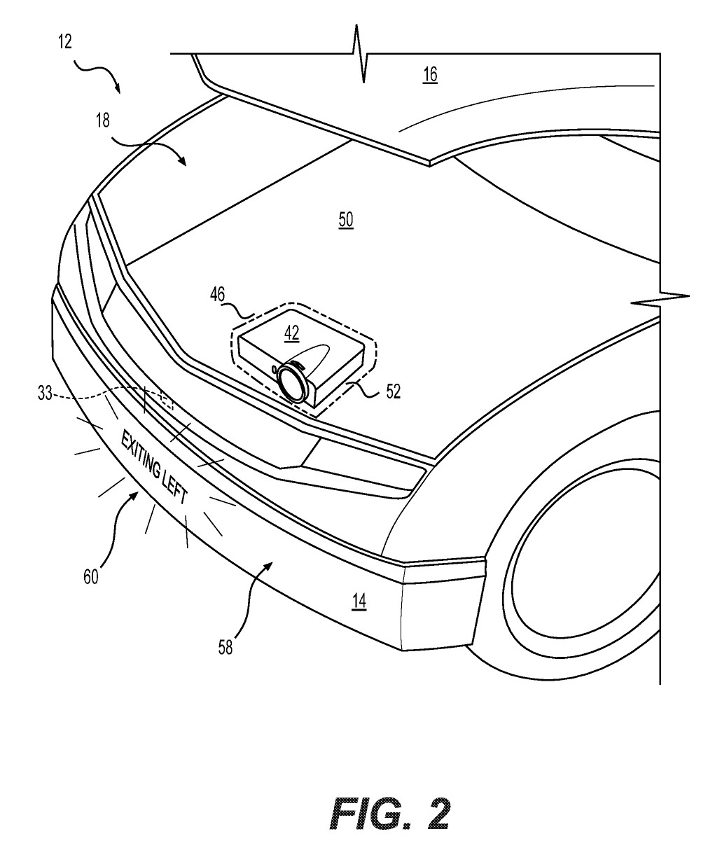

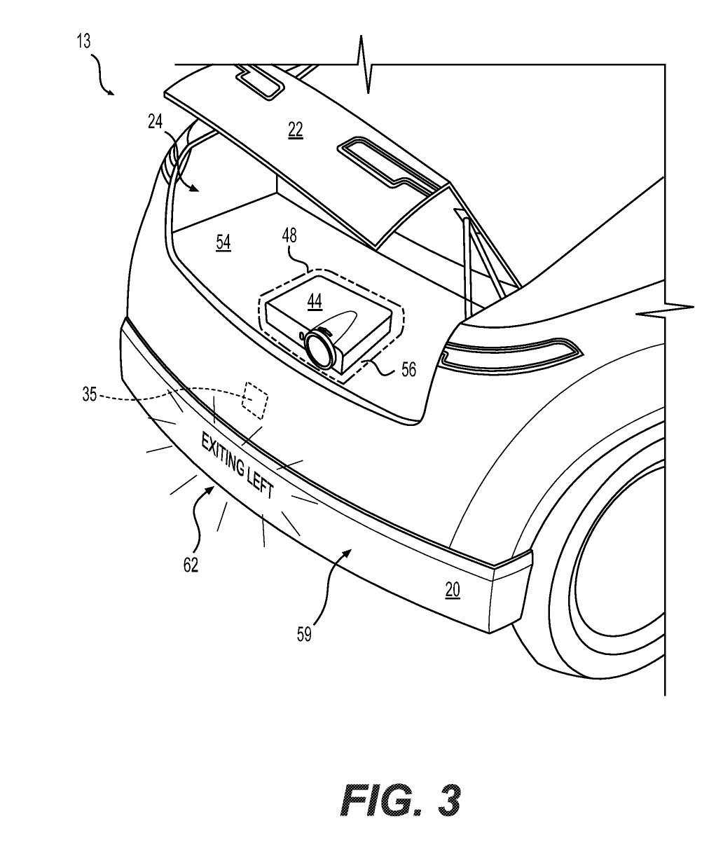

Manual input 34 is configured to receive a user input and indicate a vehicle operation. For example, if the driver moves manual control 34 in a first direction (e.g., by depressing manual control 34), vehicle 10 provides an indication of an intention to move vehicle 10 in the first direction, and if the driver moves manual control 34 in the second direction (e.g., by raising manual control 34), vehicle 10 provides an indication of an intention to move vehicle 10 in a second direction. It also is contemplated that varying degrees of actuation of manual input 34 provide different indications. For example, if the driver depresses/raises the manual control 34 to a certain extent, vehicle 10 may indicate that the driver intends to change lanes. However, if the driver depresses/raises manual control 34 more drastically (e.g., past a detent or to a stop), vehicle 10 may indicate that the driver intends to make a turn, for example, onto a cross-street. In some embodiments, the indications may be provided by an image (e.g., images 60, 62 depicted in FIGS. 2-3) projected by projector(s) 42, 44 onto an outer surface of vehicle 10 (e.g., bumper(s) 14, 20).

Projector(s) 42, 44 may be any number of devices configured to project an image. In some embodiments, projector(s) 42, 44 includes a short throw projector, such that projector(s) 42, 44 are placed within a few feet from bumper(s) 14, 20 and project on a significant portion (e.g., entire outer surface) of bumper(s) 14, 20. Projector(s) 42, 44 may be configured to provide a high definition image onto a curved surface of at least a portion of bumpers 14, 20.

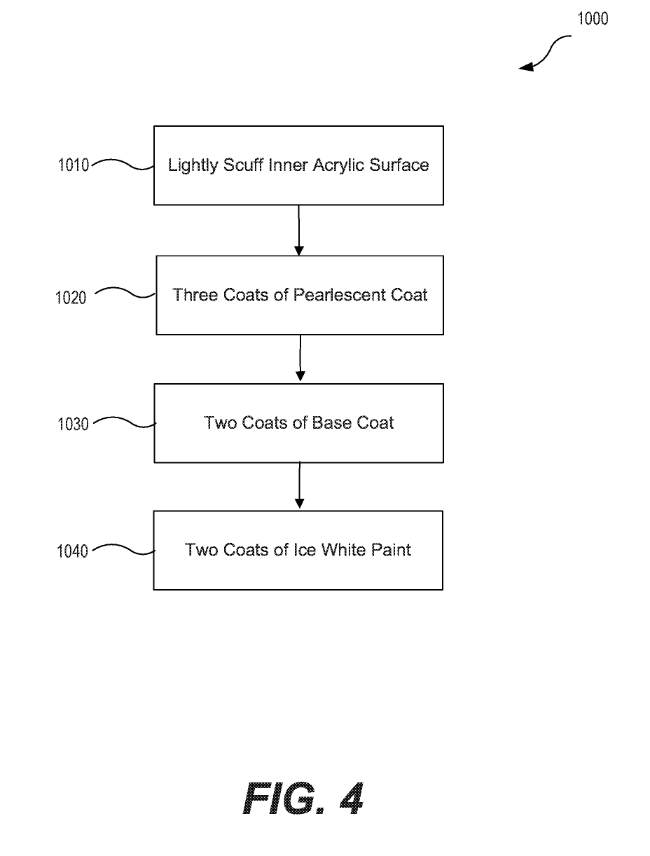

Bumpers 14, 20 may be constructed of several different materials configured to provide the desired flexibility and transparency, and may be formed in a variety of shapes to provide safety, aerodynamics, and/or aesthetics. For example, bumpers 14, 20 may each include at least a portion, or the entirety formed of, a transparent material, such as poly(methyl methacrylate) (PMMA), which is known under its trade name Plexiglas. In some embodiments, bumpers 14, 20 include a coating on an inner surface of the transparent material to form a translucent surface enhancing the image, color, and resolution of images projected by projector(s) 42, 44. In some embodiments, the coating includes a pearlescent coating configured to refract the wavelengths emitted by projector(s) 42, 44. An exemplary method of coating bumpers 14, 20 is discussed with regard to FIG. 4.

FIG. 2 provides a diagrammatic illustration of an exemplary embodiment of front end 12 of vehicle 10. As depicted in FIG. 2, cargo space 18 is enclosed by front hood 16 and a floor 50 providing storage space to hold items, such as luggage, groceries, and/or other objects. Floor 50 may be defined by carpeting, and/or one or more rigid panels (e.g., automotive metal or plastic). Front end 12 also includes compartment 46 positioned underneath floor 50, for example, enclosed between floor 50 and a subfloor 52. In some embodiments, compartment 46 may be accessible by a removable hatch of floor 50. Bumper 14 includes an outer surface 58, and an opposing inner surface (not shown).

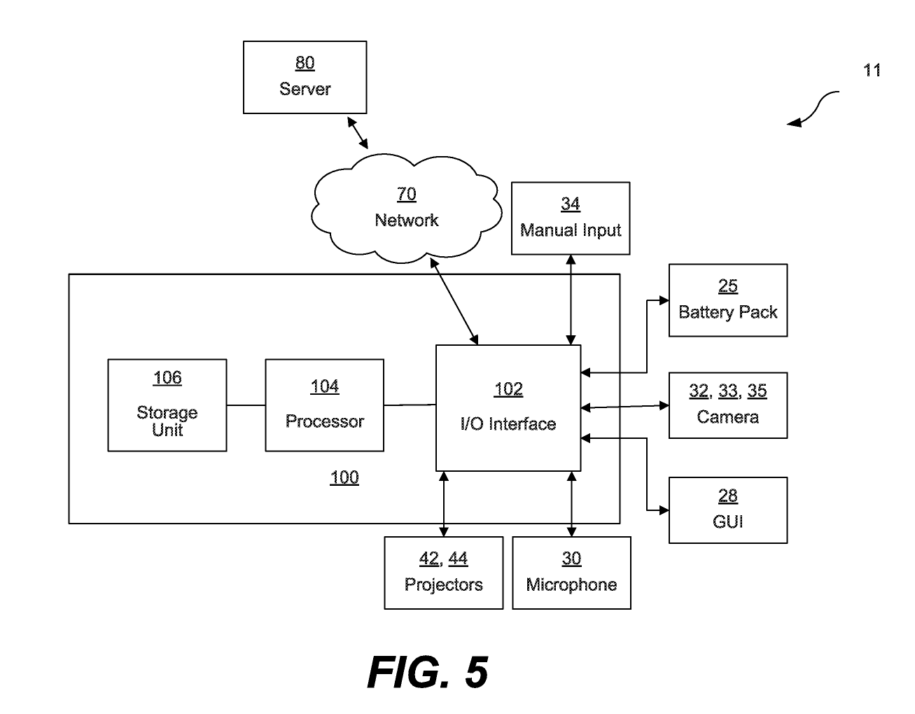

Projector 42 is controlled to display image 60 onto an outer surface of vehicle 10 (e.g., outer surface 58 of bumper 14), and image 60 may provide a variety of types of information. For example, image 60 may be projected through the inner surface of bumper 14 to be displayed on at least a portion of outer surface 58 of bumper 10, that is viewable by a person outside of vehicle. Image 60 may include text (e.g., “Exiting Left”) that may be stationary or moving relative to external surface 58. Image 60 may additionally or alternatively include video, animation, color, shading, gauges, meters, symbols, and/or schematic indicators. For example, image 60 may display information from a variety of sources as discussed below regarding FIG. 5.

FIG. 3 provides a diagrammatic illustration of an exemplary embodiment of rear end 13 of vehicle 10. As depicted in FIG. 3, cargo space 24 is enclosed by rear hood 22 and a floor 54 providing storage space to hold items, such as luggage, groceries, and/or other objects. Floor 54 may be defined by carpeting and/or one or more rigid panels (e.g., automotive metal or plastic). Rear end 13 includes compartment 48 positioned underneath floor 54, for example, enclosed between floor 54 and a subfloor 56. In some embodiments, compartment 48 may be accessible by a removable hatch of floor 54. Bumper 20 includes an outer surface 59, and an opposing inner surface (not shown).

Projector 44 is controlled to display image 62 onto an outer surface of vehicle 10 (e.g., outer surface 59 of bumper 20), and image 62 may provide a variety of types of information. For example, image 62 may be projected through the inner surface of bumper 14 to be displayed on at least a portion of outer surface 59 of bumper 20, that is viewable by a person outside of vehicle. Image 62 may include text (e.g., “Exiting Left”) that may be stationary or moving relative to external surface 59. Image 62 may additionally or alternatively include video, animation, color, shading, gauges, meters, symbols, and/or schematic indicators. For example, image 62 may display information from a variety of sources as discussed below regarding FIG. 5.

FIG. 4 is a flowchart illustrating an exemplary method 1000 that may be performed in production of exemplary vehicle 10 of FIG. 1. For example, method 1000 may be practiced to apply a coating onto any number of surfaces of vehicle 10, such as onto a transparent material, such as PMMA, forming at least a portion of an external member of vehicle 10, e.g., bumper 14, 20. In some embodiments, the transparent material may be at least a portion of bumpers 14, 20 to enable projection thereon of images 60 and 62 by projectors 42 and 44, respectively. The translucent coating may be applied onto only the inner surface of the transparent material to form a translucent surface, which advantageously provides an appearance of the transparent material of bumpers 14, 20 as having a similar color to the rest of vehicle 10, while forming the translucent surface with a translucent material, such that an image from projector 42, 44 can be projected onto the translucent surface. The translucent surface may be configured to refract specific wavelengths of light creating favorable image, color, and resolution of an image projected thereon.

Method 1000 may include applying one or more layers of pearlescent paint, in a number of different orders. The layers may include a base paint, such as a Xyrellic Pearl Basecoat (XPB-Base) such as, for example, manufactured by PPG. The layers may also include an Ice White F1 Paint, produced, for example, by thoroughly mixing 40 grams of the XPB-Base with 3 grams of Ecket OEM fine silver. The layers may further include an Ice White F1 Pearl Paint, produced, for example, by diluting the Ice White F1 Paint at a ratio of 1 part to 1.5 parts of XPS90030 Durethane Solvent Reducer. One or more of the coatings may be applied using a spray gun at a pressure between about 18 and 22 psi.

Although discussed regarding bumpers 14, 20, method 1000 may be applied to any number of other surfaces of vehicle 10. For example, it may be applied to a rear or side surface of a bus to display advertisements. Furthermore, modifications to the one or more layers may vary depending on the degree of desired color matching to the rest of vehicle 10.

In step 1010, the inner surface of bumpers 14, 20 is lightly scuffed in order to aid in paint adhesion.

In step 1020, at least one pearlescent coat is applied to the lightly scuffed inner surface of bumpers 14, 20. For example, in some embodiments, three coats of Ice White F1 Pearl Paint are applied to the inner surface of bumpers 14, 20. The pearlescent coat is configured to refract specific wavelengths of light to create a favorable image, color, and resolution.

In step 1030, at least one base coat is applied to the inner surface of bumpers 14, 20 on the pearlescent coat. For example, in some embodiments, two coats of XPB-Base are applied to the inner surface of bumpers 14, 20.

In step 1040, at least one coat of ice white paint is applied on the base coat. For example, in some embodiments, two coats of Ice White F1 Pearl Paint are applied to the inner surface of bumpers 14, 20 on the XPB-Base coat.

In some embodiments, steps 1030 and 1040 are omitted.

While method 1000 includes use of Ice White F1 paint in both steps 1020 and 1040, the disclosure is not so limited. Method 1000 may be practiced with equal effectiveness using a paint color other than Ice White.

FIG. 5 provides a block diagram of an exemplary projector system 11 that may be used with vehicle 10. As illustrated in FIG. 5, projector system 11 includes a controller 100 having, among other things, an I/O interface 102, a processor 104, and a storage unit 106. One or more of the components of controller 100 may be included in an on-board computer of vehicle 10. These units may be configured to transfer data and send or receive instructions between or among each other.

I/O interface 102 is configured for two-way communication between controller 100 and various components of projector system 11, such as battery pack 25, GUI 28, microphone 30, cameras 32, 33, 35, manual input 34, projector(s) 42, 44, and/or a server 80 via communication cables, wireless networks, or other communication mediums. I/O interface may also send and receive operating signals to and from battery pack 25, GUI 28, microphone 30, cameras 32, 33, 35, manual input 34, projector(s) 42, 44, and/or server 80.

Processor 104 is configured to receive and process signals to determine a plurality of conditions of the operation of vehicle 10. Processor 104 may also be configured to generate and transmit command signals, via I/O interface 102, in order to actuate the devices in communication. For example, processor 104 may be configured to display images on GUI 28, actuate cameras 32, 33, 35, and/or actuate projector(s) 42, 44 to display images 60, 62.

In some embodiments, processor 104 may be configured to receive signals indicating a condition that the vehicle has been unlocked and/or started, and control projectors 40, 42 to display images or animation indicating the condition.

In some embodiments, processor 104 is configured to receive an input from occupants and control projectors 40, 42 to project images 60, 62 according to the input. For example, processor 104 may be configured to receive a signal indicative of an intended movement of the vehicle and actuate projector(s) 42, 44 to project the image based on the signal. For instance, if the occupant raises/depresses manual input 34, projector(s) 42, 44 projects image(s) 60, 62, such as “CHANGING LANES” or “TURNING LEFT/RIGHT.” Processor 104 may also receive an input from occupants through GUI 28, microphone 30, and/or camera 32. For example, the occupant may request turn-by-turn directions to a destination through GUI 28, which is relayed to projector(s) 42, 44. For example, when vehicle 10 is approaching an exit ramp en route to the destination, images 60, 62 may display “EXITING LEFT.” Processor 104 may receive verbal commands from occupant(s) through microphone 30, and display images 60, 62 via projector(s) 42, 44. For example, if the occupant says “I want to exit left” or “Tell the vehicle behind me that their brights are on,” processor 104 may generate a signal to projector(s) 42, 44 to project an indicative images 60, 62. Processor 104 may also be configured to generate a signal to projector(s) 42, 44 based on detected gestures, according to image recognition software. For example, processor 104 may be configured to detect hand gestures and/or facial expressions that are predefined to indicate an images 60, 62 to be projected by projector(s) 42, 44.

In some embodiments, processor 104 is configured to control projectors 42, 44 to display images 60, 62 in order to provide information about the occupants. For example, processor 104 may be configured to aggregate data from microphone 30 and camera 32 to determine physical and/or mental conditions of occupant(s), such as sleep deprivation, intoxication, attentiveness, distraction, and/or other activities. For example, processor 104 may be configured to detect eye movement of the driver, and/or based on images from camera 33 or a movement sensor mounted on front end 12, determine that a pedestrian is within the driver's sightline, and indicate to the pedestrian that it is safe for them to cross the pathway of vehicle 10. For example, processor 104 may be configured to generate a signal to project images 60, 62, which can be animations that represent the movement of pedestrians as they cross the pathway of the vehicle. Similarly, processor 104 may be configured to detect movement behind vehicle 10 based on images from camera 35 or a movement sensor mounted on rear end 13, to determine the presence of a pedestrian, and generate a signal to project images to indicate it is safe for the pedestrian to cross behind vehicle 10. Processor 104 may also process data from microphone 30 and/or camera 32 to detect slurred speech, dilated pupils, closing eyelids, and/or misdirected eye movement, and generate a signal to project warning images 60, 62, such as “DISTRACTED DRIVER” or “DRUNK DRIVER.” In some embodiments, images 60, 62 may improve aesthetics, such as creating virtual shadows representing people that are crossing in front of vehicle 10.

In some embodiments, processor 104 is configured to receive data from server 80 and project images 60, 62. For example, processor 104 may be configured to receive data from server 80 related to social media, advertisements, traffic information, road hazards, weather, and/or emergency information (e.g., amber alerts). Processor 104 may then control projectors 42, 44 to project images 60, 62 based on the received data to be viewed by people outside of vehicle 10. For example, processor 104 may be configured to integrate social media feeds of passengers, and project images 60, 62.

In some embodiments, processor 104 is configured to receive data from sensors of vehicle 10, and project the data in images 60, 62. For example, processor 104 may be configured to project information, such as a current battery life of battery pack 25, charging status, scheduled maintenance, fluid levels, temperatures, tire status, and/or other similar types of data. In this manner, processor 104 may provide information to the person without have to enter cabin 26. Processor 104 may also be configured to project information.

For example, with regard to charging status, processor 104 can be configured to control projectors 42, 44 to project images 60, 62 such as an animation indicating that the vehicle is charging, including text that indicates an estimated time until vehicle 10 is charged.

In some embodiments, processor 104 may be configured to detect the presence of a known mobile device of a person associated with vehicle 10 (e.g., an owner) and control projectors 42, 44 to project information based on the data received from the sensors of vehicle 10, e.g., battery life, charging status, fluid levels, etc.

In some embodiments, processor 104 is configured to provide information for ride sharing functions, such as taxi cabs, Uber™, and/or Zipcar™. For example, when a driver is approaching a person that he intends to pick up, the images 60, 62 may display the person's name, the driver's name, a destination of the vehicle, the number of passenger seats available, a rating of the driver, and/or advertise a fare. Also, for example, processor 104 may be configured to detect that a person the driver is approaching is a ride share user, and control projectors 42, 44 to project images 60, 62 to suitably notify the rideshare user.

In some embodiments, processor 104 may be applied to the race car industry. For example, images 60, 62 may display an assigned number, livery colors (e.g., team colors), overall position of the vehicle or team, driver response time, breaking force, speed, g-forces, and/or any other similar types of data.

Storage unit 106 is configured to store one or more computer programs for execution by controller 100 to perform functions of projector system 11. For example, storage unit 106 may be configured to store software for image processing software, e.g., image recognition software, such that the software may distinguish a person from inanimate objects, and distinguish identities, facial features, and/or other biometric aspects of users. Storage unit 106 may also be configured to store look-up charts including data, such as, a maintenance schedule, indicative levels of battery life, and/or personal information of occupants.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage unit or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed remote control system and related methods. It is intended that the specification and examples be considered as exemplary only, with a true scope being indicated by the following claims and their equivalents.

What is claimed is:

1. A projector system for a vehicle, the projector system comprising:
an external member including a bumper, wherein at least a portion of the external member is formed of a transparent material, the portion including a translucent surface; and
a projector configured to project an image onto the translucent surface.

2. The projector system of claim 1, wherein the portion of the external member formed of a transparent material includes a polymer, and the translucent surface is formed from a coating configured to refract the image.

3. The projector system of claim 1, further including a controller configured to receive a signal relating to the vehicle and actuate the projector to project the image based on the signal.

4. The projector system of claim 3, further including a battery sensor configured to detect a battery life of the vehicle and generate the signal to the controller as a signal representative of the detected battery life, wherein the controller is configured to actuate the projector to project the image to include the detected battery life based on the signal.

5. The projector system of claim 3 wherein the controller is configured to detect a mobile device within proximity of the vehicle, and actuate the projector to project the image based on the detected mobile device.

6. The projector system of claim 3, further including sensors to detect at least one of battery life, charging status, fluid levels, temperatures, tire status, or ridesharing information; wherein the controller is configured to detect a mobile device within proximity of the vehicle and project the image based on at least one of the battery life, charging status, fluid levels, temperatures, tire status, or ride sharing information.

7. The projector system of claim 3, further including a user interface configured to receive an input from a user and output a signal, wherein the projector is configured to output the image based on the signal.

8. The projector system of claim 3, wherein the controller is configured to receive information pertaining to an intended movement of the vehicle and actuate the projector to project the image based on the signal.

9. The projector system of claim 1, further including a sensor configured to detect a physical feature of an occupant and generate a signal, wherein the controller is configured to actuate the projector to project the image based on the signal.

10. The projector system of claim 1, wherein the projector is configured to be housed in a compartment below a cargo space of the vehicle.

11. The projector system of claim 1, wherein the controller is configured to detect presence of a pedestrian in front of the vehicle, and to activate the projector to project the image to represent a movement of pedestrians crossing the front of the vehicle.

12. A method of displaying an image onto a vehicle comprising:
receiving, with a projector, a signal; and
projecting, with the projector, the image based on the signal onto a translucent surface of an external member of the vehicle including a bumper, wherein at least a portion of the external member is formed of a transparent material and has the translucent surface.

13. The method of claim 12, further including detecting, with a battery sensor, a battery life of the vehicle, wherein the signal is generated based on the battery life.

14. The method of claim 12, further including generating the signal based on an intended movement of the vehicle.

15. The method of claim 12 further including:
detecting movement of a pedestrian in front of the vehicle; and generating the signal to indicate to the pedestrian that it is safe to cross in front of the vehicle.

16. A vehicle comprising:
a projector system including:
an external member including a bumper, wherein at least a portion of the external member is formed of a transparent material and includes a translucent surface; and
a projector configured to project an image onto the translucent surface.

17. The vehicle of claim 16, further including a cargo space defined by a floor, wherein the projector is located below the floor.

18. The vehicle of claim 16, wherein the projector system further includes a controller comprising a processor configured to receive a signal relating to the vehicle and actuate the projector to project an image onto the translucent surface.

19. The vehicle of claim 16, wherein the projector system further includes a battery sensor configured to detect a battery life of the vehicle and generate the signal to the controller as a signal representative of the detected battery life, wherein the controller is configured to actuate the projector to project the image to include the detected battery life based on the signal.

20. The vehicle of claim 16, wherein the projector system further includes a user interface configured to receive an input from a user and generate a signal, wherein the controller is configured to output an image to the projector based on the signal.
